(19) United States
(12) Patent Application Publication
(10) Pub. No.: US 2013/0141183 A1
(43) Pub. Date: Jun. 6, 2013

(54) DIRECTIONAL COUPLER INTEGRATED BY CMOS PROCESS

(71) Applicants: Le Ye, Beijing (CN); Jiayi Wang, Beijing (CN); Huailin Liao, Beijing (CN); Ru Huang, Beijing (CN)

(72) Inventors: Le Ye, Beijing (CN); Jiayi Wang, Beijing (CN); Huailin Liao, Beijing (CN); Ru Huang, Beijing (CN)

(73) Assignee: PEKING UNIVERSITY, BEIJING (CN)

(21) Appl. No.: 13/641,647

(22) PCT Filed: Apr. 16, 2012
(86) PCT No.: PCT/CN2012/074063

§ 371 Date: Oct. 16, 2012

(30) Foreign Application Priority Data
Dec. 5, 2011 (CN) 201110399962.5

(51) Int. Cl. H01P 5/16

(52) U.S. Cl. 333/111; 333/112

(57) ABSTRACT

A directional coupler is disclosed integrated on a single chip and an integrated circuit based on a standard CMOS process and relates to a field of radio frequency communication. In exemplary implementations, by using a standard CMOS process technology, the directional coupler integrated by a CMOS process is formed by a coil winded by a upper layer of metal lines, a coil winded by a lower layer of metal lines, two tuning capacitor array, and a matching resistor. Two terminals of the coil are a direct terminal and an input terminal; two terminals of the coil are a coupled terminal and an isolation terminal; the terminals of the coils and are intersected at 90°; the coil is winded by an upper metal layer and the coil is winded by a lower metal layer. Further, the insertion loss is low and the isolation degree is large.

### CROSS-REFERENCE TO RELATED APPLICATION

The present application claims priority to a Chinese application No. 201110399962.5, filed on Dec. 5, 2011, which is incorporated herein by reference.

### FIELD OF THE INVENTION

The present invention relates to the field of a radio frequency integrated circuit technology, and particularly relates to a on-chip integration directional coupler and an integrated circuit by using a standard CMOS process.

### BACKGROUND OF THE INVENTION

A directional coupler is a radio frequency device widely used for a signal isolation, a signal separation, etc., and is used to make a radio frequency receiver and a radio frequency transmitter operate at the same frequency band. FIG. 1 illustrates a principle of a directional coupler used in a transceiver system, an input terminal (Input) is connected to an output terminal of a transmitter (TX), and a direct terminal (Direct) is connected to an antenna (Antenna), a coupled terminal (Coupled) is connected to an input terminal of a receiver (RX), an isolated terminal (Isolated) is connected to a matching resistor (Res). There are some definitions for the directional coupler. A loss from the input terminal to the direct terminal is referred as an insertion loss (Insertion Loss), a loss from the input terminal to the coupled terminal is referred as a coupling degree (Coupling), a loss from the direct terminal to the coupled terminal is referred as an isolation degree (Isolation), a difference between the isolation degree to the coupling degree is referred as directivity (Directivity). It is required that the insert loss is very low, the coupling degree is not very large, and the isolation degree is very large, that is, the directivity is strong. For a transceiver system with the same frequency for receiving and transmitting, the energy for transmitting a signal is generally large and a large portion thereof may be coupled to the input terminal of the receiver, however, a receiving signal is very weak and a very strong output coupling signal may affect the useful receiving signal if a directional coupler is not used, which may cause the receiver not operate properly, as shown the left part of FIG. 2. After the directional coupler is used, the receiving signal may be partially lost due to the coupling degree, and meanwhile the transmitting signal coupled to the input terminal is greatly attenuated. Thus, the transceiver with the same frequency for receiving and transmitting may operate properly, as shown the right part of FIG. 2.

Generally, a conventional directional coupler is fabricated by using a transmission line, as described in a reference (Hilal Ezzeddine et al., “Directional coupler”, U.S. patent, U.S. Pat. No. 7,394,333 B2, Jul. 1, 2008). The conventional directional couplers have a large volume, complicated assembling processes and high costs. Then, in order to miniaturize the directional coupler, separated components are used, as described in a reference (Oleksandr Gorbachov, “Directional coupler for RF power detection”, U.S. patent, U.S. Pat. No. 7,576,626 B2, Aug. 18, 2009). However, such a directional coupler is still unable to be integrated. With the rapid development of the integrated circuit, the on-chip integration is a tendency in future. An integrated directional coupler expands the applicability and has a lower cost, and is applied for, for example, a radio frequency identification (RFID Reader) and so on. In order to implement a on-chip integration for the directional coupler, some special processes are employed, as shown in a reference (Shim, S., Hong, S., “A CMOS Power Amplifier With Integrated-Passive-Device Spiral-Shaped Directional Coupler for Mobile UHF RFID Reader,” Microwave Theory and Techniques, IEEE Transactions on , vol. PP, no. 99, pp. 1, 0). The reference describes a directional coupler fabricated by using an integrated passive device (IPD) process. Though the directional coupler has a small volume, a special processing technology that can not be compatible with a standard CMOS process is used, the cost is high, and a complicated process is used. Thus, it is difficult to achieve an over-chip integration for the directional coupler, and the practical applicability of the directional coupler is limited.

At present, the solution or technology for implementing the directional coupler as described in the known references and patents do not implement the directional coupler by using a standard CMOS process, which greatly limits the application range thereof. For example, in the field of the mobile communication system, miniaturization and portability are highly required. Though some directional couplers have met the requirement of miniaturization, the usage of special process causes a high cost and it is hardly to meet the requirements of the system integration.

### SUMMARY OF THE INVENTION

Therefore, it is an object of the present invention to provide a directional coupler integration technology and an integrated circuit based on a standard CMOS process. The technology has a feature that the on-chip integration can be achieved by using a standard silicon-based CMOS process, and has a small area, a low input loss, a high coupling degree, a high isolation degree and a strong tuning ability.

The above object of the present invention is achieved by the following technical solution.

A directional coupler integration technology and integrated circuit based on a standard CMOS process are provided as follows (as shown in FIGS. 3 and 4).

(1) A coil 1 is provided between an input terminal (Input) and a direct terminal (Direct) and is winded by a Mth metal layer, and an intersect portion thereof is connected by (M−1) th metal layer; a coil 2 is provided between an input terminal (Input) and an isolated terminal (Isolated) and is winded by an Nth metal layer, and an intersect portion thereof is connected by (N+1) th metal layer, wherein N≧1, M≧N+2. Thus, a stereochemical structure is formed.

(2) The coils 1 and 2 are winded in a shape of a square shape, a circle shape, a rectangle shape, an octagon shape or other polygon shape.

(3) The two ends of the coil 1 and the two ends of the coil 2 form an angle of 90°, the distance between the direct terminal (Direct) and the coupled terminal (Coupled) is small, while the distance between the input terminal (Input) and the coupled terminal (Isolated) is large.

(4) Metal coils of the coil 1 and the coil 2 are intersectly arranged, a center of an upper/lower metal line is alignned with a center of a lower/upper metal line, the upper and lower metal lines have an excessive overlap O (also may have no excessive overlap), that is, the line width W of the metal line may be larger than or equal to or smaller than the interval S between the metal lines.

(5) An adjustable capacitor array Cp is disposed between the input terminal and the direct terminal to achieve a frequency tuning.

(6) An adjustable capacitor array Cs is disposed between the coupled terminal and the isolated terminal to achieve an isolation degree tuning.

The principle of the present invention is described as follow.

(a) A directional coupler is equivalent to a passive transformer with a changed structure. For a general passive transformer, four terminal parameters are symmetrical. However, the directional coupler uses the asymmetry of space and position to effect the differences among the four terminal parameters. Two terminals of coil 1 (in this disclosure, the coil 1 may be square, rectangle, circle, octagon or other polygon) winded by a Mth metal layer and two terminals of coil 2 (in this disclosure, the coil 1 may be square, rectangle, circle, octagon or other polygon) winded by a Nth metal layer are perpendicular at 90°. By using the space asymmetry, the four terminal circuit parameters are different and show a directionality. The direct terminal (Direct) and the input terminal (Input) are two terminals of an identical layer of coil. The coupled terminal (Coupled) and the isolated terminal (Isolated) are two terminals of another identical layer of coil. The distance between the direct terminal (Direct) and the coupled terminal (Coupled) is small and the distance between the input terminal (input) and the isolation terminal (Isolated) is larger.

(b) The coils 1 and 2 have different shapes, radiuses (minimum inner radius is D1 and maximum outer radius is D2) and coil numbers. The coils 1 and 2 may use metal lines with different line widths W and different intervals S. The insertion loss (Insertion Loss), coupling degree (Coupling), isolation degree (Isolation) and directivity (Directivity), etc. may be adjusted by changing the metal line at different layers (or by changing the vertical interval between the upper metal line and the lower metal line).

(c) Generally, the directional coupler is designed so that the outputs of power amplifiers are well matched. However, in practice, the outputs of the transmitter power amplifier are poorly matched and variations of output power may lead to variation of the match of the power amplifier, so that there is a deviation between the practical performance and the design value of the directional coupler. In additional to the above problems, the factors such as process fluctuation and temperature variation and the like may cause deterioration of performance of the directional coupler.

The directional coupler uses a capacitor Cp for a frequency tuning and a capacitor Cs for an isolation degree tuning to address the above problems.

The present invention has the following advantages.

(1) The input loss is low. The input terminal (Input) and the direct terminal (Direct) are connected by a Mth metal layer (at the crossing connected by (M−1)th metal layer), an upper metal layer (with respect to a metal layer used by another layer of coil) has a small parasitic capacitance with respect to the ground, and the matching resistor of an isolation terminal of a lower layer of coil are grounded, a portion of a parasitic capacitance of the upper layer of coil is shielded by the lower layer of coil, so that the input loss is very small.

(2) The directivity is good. The present invention uses a stereochemical coil structure which includes a coil 1 formed by a Mth metal layer and a coil 2 formed by an Nth metal layer (N≧1, M≧N+2), and a vertical distance H is larger. The upper and lower metal layer are intersectly arranged in a vertical direction, line width centers of upper/lower metal layer and interval centers of lower/upper metal lines are aligned with each other in the vertical direction. There is an excessive overlap (also no the excessive overlap) at the edge of the metal layer. Those features mentioned above make the isolation degree greatly increase, the directivity become better, as shown in FIG. 5 (a simulation result at the operation frequency of the transceiver is 875 MHz).

(3) The area is small. Since the stereochemical coil structure is used and the upper and lower metal layer are intersectly arranged, in the case of the same identical directivity requirement, the interval between the metal lines may be smaller, the whole structure of the directional coupler may be more compact and area thereof may be smaller, as compared with a flat coil structure.

(4) The applicability range is wide. During the design process, by changing the shapes (e.g. square, rectangle, circle, polygons such as octagon), coil numbers, radiuses (minimum inner radius D1, maximum outer radius D2) of the coils 1 and 2, the interval between the metal layers used by coils 1 and 2 (e.g. selecting the metal at different layers as the lower or upper layer to change the vertical interval H between the upper and lower layer of metal coil), and the depth O excessively overlapped between two coils, the magnitudes of insertion loss, coupling degree, isolation degree and directivity may be flexibly changed. Also, the above factors may be changed to meet with different requirements of different systems.

(5) The tuning ability is good. A capacitor Cp is introduced for a frequency tuning and a capacitor Cs is introduced for an isolation degree tuning. As such, the actual operation of the device may be prevented from deteriorating due to the nonideal effects resulted from a poor matching between the outputs of the transmitters (TX), and a varied output matching under different output powers, a process fluctuation and a temperature variation.

(6) The device of the present invention may be integrated into a single chip with the standard silicon-based CMOS process and may also be integrated with a BiCMOS process, a HBT process and so on. The device may be used as a module to be integrated with other circuits and systems over a single chip. Thus, a cost is reduced, and system integration degree may be greatly increased.

### BRIEF DESCRIPTION OF THE DRAWINGS

The present invention will be described in more detail below in conjunction with the attached drawings.

FIG. 1 is a principle diagram of a directional coupler used in a general transceiver system;

FIG. 2 is a principle diagram of a directional coupler for restraining the coupling portion of a transmitting signal in a receiving signal;

FIG. 3 is plan view showing a layout of a novel directional coupler based on a standard CMOS process of the present invention;

FIG. 4 is cross sectional view taken along a line A3 of the layout of the novel directional coupler based on a standard CMOS process of the present invention;

FIG. 5 is a graph showing the performance of the novel directional coupler based on a standard CMOS process of the present invention; and

FIG. 6 is a schematic diagram of an embodiment of the present invention.

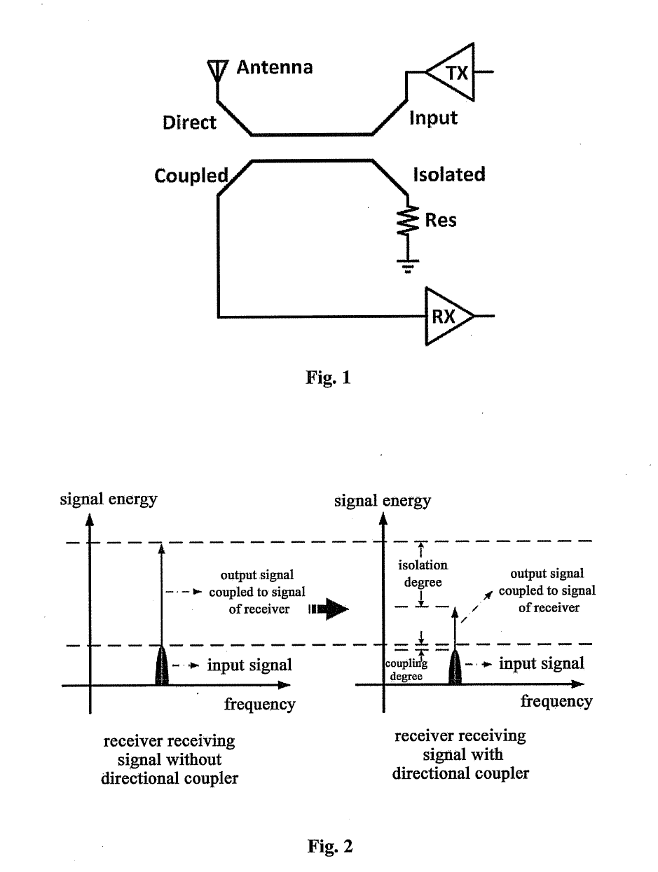

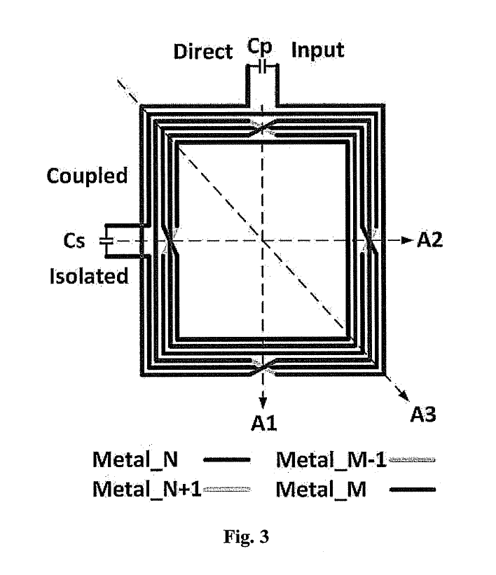

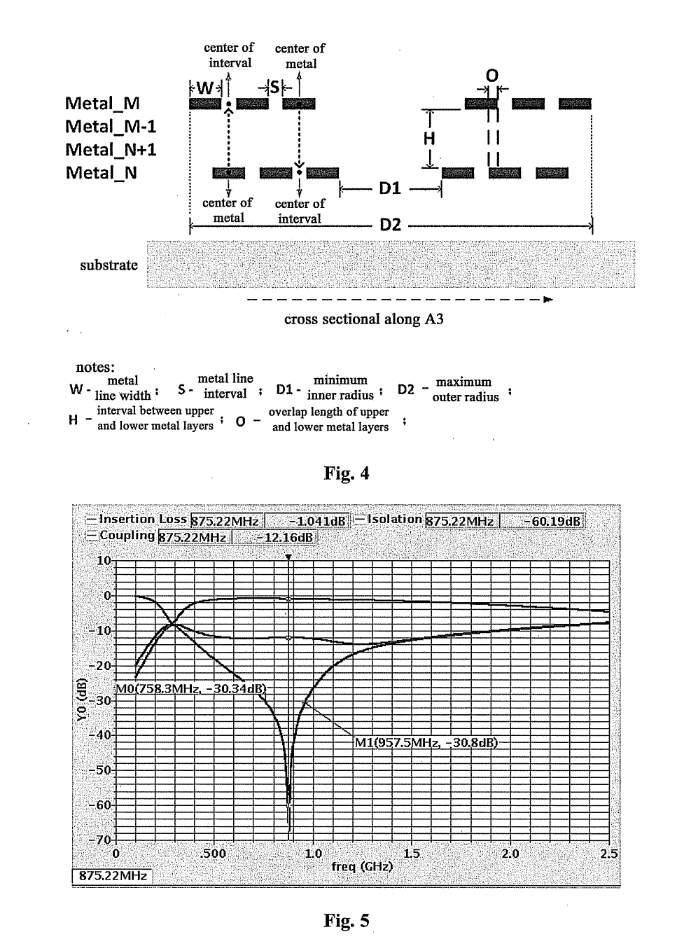

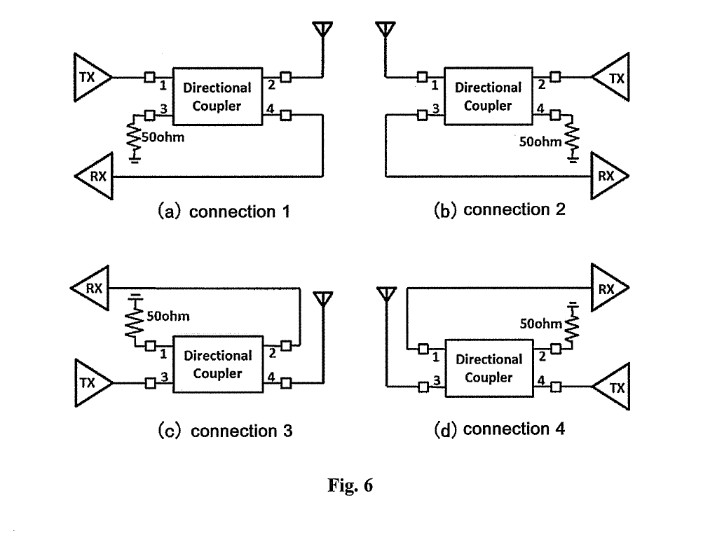

### DETAILED DESCRIPTION OF THE EMBODIMENTS

For the purpose of detailed illustration of the present invention, a specified embodiment is described below.

A directional coupler integrated by a CMOS process of the present invention may be connected to a transmitter, a receiver, an antenna and a matching resistor to form a transceiver which operates at the same frequency simultaneously. As a radio frequency identification reader achieved by the present invention shown in FIG. 6, the receiver and the transmitter may be simultaneously operated at the same frequency.

A terminal 1 in FIG. 6 is an input terminal (Input) of the directional coupler integrated by CMOS process, a terminal 2 in FIG. 6 is a direct terminal (Direct), a terminal 3 in FIG. 6 is an isolated terminal (Isolated), and a terminal 4 in FIG. 6 is a coupled terminal (Coupled).

The directional coupler integrated by CMOS process may be connected as shown in FIG. 6(a). The terminal 1 is connected with an output terminal of the transmitter (TX), the terminal 2 is connected to the antenna (Antenna), the terminal 3 is connected to a grounded resistor (Res) of 50 ohm, and the terminal 4 is connected to an input terminal of the receiver (RX). The definitions of respective parameters are as follows: S12 (S21) corresponds to the insertion loss, S24 (S42) corresponds to the coupling degree, and S14 (S41) corresponds to the isolation degree.

The directional coupler integrated by CMOS process may also be connected as shown in FIG. 6(b). The terminal 2 is connected with the output terminal of the transmitter (TX), the terminal 1 is connected to the antenna (Antenna), the terminal 4 is connected to the grounded resistor (Res) of 50 ohm, and the terminal 3 is connected to the input terminal of the receiver (RX). The definitions of respective parameters are as follows. S12 (S21) corresponds to the insertion loss, S13 (S31) corresponds to the coupling degree, and S23 (S32) corresponds to the isolation degree.

The directional coupler integrated by CMOS process may also be connected as shown in FIG. 6(c). The terminal 3 is connected with the output terminal of the transmitter (TX), the terminal 4 is connected to the antenna (Antenna), the terminal 1 is connected to the grounded resistor (Res) of 50 ohm, and the terminal 2 is connected to the input terminal of the receiver (RX). The definitions of respective parameters are as follows. S34 (S43) corresponds to the insertion loss, S24 (S42) corresponds to the coupling degree, and S23 (S32) corresponds to the isolation degree.

The directional coupler integrated by CMOS process may also be connected as shown in FIG. 6(d). The terminal 4 is connected with the output terminal of the transmitter (TX), the terminal 3 is connected to the antenna (Antenna), the terminal 2 is connected to the grounded resistor (Res) of 50 ohm, and the terminal 1 is connected to the input terminal of the receiver (RX). The definitions of respective parameters are as follows. S34 (S43) corresponds to the insertion loss, S31 (S13) corresponds to the coupling degree, and S14 (S41) corresponds to the isolation degree.

A directional coupler technology and integrated circuit based on a standard CMOS process is described through the specific embodiments mentioned above, those skilled in the art of the filed may make various change in terms of forms and contents according to the above steps without departing from the substantial scope protected by the present invention. Thus, the present invention is not limited to the content disclosed in the embodiments.

What is claimed is:

1. A directional coupler based on a CMOS process, comprising the following steps:
(1) a coil 1 which is winded by a Mth metal layer and is connected between an input terminal (Input) and a direct terminal (Direct), and an intersect portion of which is connected by (M−1) th metal layer; a coil 2 which is winded by an Nth metal layer and is connected between a coupled terminal (Coupled) and an isolated terminal (Isolated), and an intersect portion of which is connected by (N+1) th metal layer and the coil 1 and the coil 2 form a stereochemical structure, wherein N≧1,M≧N+2;
(2) the coils 1 and 2 are winded in a shape of a square, a circle, a rectangle, an octagon or other polygon;
(3) two ends of the coil 1 and two ends of the coil 2 form an angle of 90°, a distance between the direct terminal (Direct) and the coupled terminal (Coupled) is small while a distance between the input terminal (Input) and the coupled terminal (Isolated) is large;
(4) metal lines of the coil 1 and the coil 2 are intersectly arranged vertically, centers of upper/lower layer metal lines are alignned with centers of lower/upper layer metal lines, the upper and lower layer metal lines have an excessive overlap (O), that is, a line width of the metal line is larger than or equal to or smaller than an interval S between the metal lines;
(5) an adjustable capacitor array Cp is disposed between the input terminal and the direct terminal to achieve a frequency tuning; and
(6) an adjustable capacitor array Cs is disposed between the coupled terminal and the isolated terminal to achieve an isolation degree tuning.

2. An integrated circuit used for a directional coupler tuning technology, wherein, the integrated circuit comprises an integrated directional coupler according to claim 1, and
the directional coupler changes a frequency of a lower concave point of an isolation degree curve by changing the adjustable capacitor array Cp, and changes a down concaved depth of the isolation degree curve by changing the adjustable capacitor array Cs.

3. The integrated circuit of claim 2, wherein, the integrated circuit is fabricated by a standard CMOS process or a BiCMOS/BJT/HBT process.
